(19) United States
(12) Patent Application Publication
(10) Pub. No.: US 2010/0272193 A1
(43) Pub. Date: Oct. 28, 2010

(54) DATA COMMUNICATION USING 2D BAR CODES

(75) Inventors: Farooq Khan, Allen, TX (US); Jiann-An Tsai, Plano, TX (US); Sridhar Rajagopal, Plano, TX (US); Bill Semper, Richardson, TX (US); Zhouyue Pi, Richardson, TX (US); Ying Li, Garland, TX (US)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/561,015

(22) Filed: Sep. 16, 2009

Related U.S. Application Data
(60) Provisional application No. 61/214,520, filed on Apr. 24, 2009.

(51) Int. Cl. H04L 27/00

(52) U.S. Cl. 375/259; 375/316

(57) ABSTRACT

A Two-Dimensional (2D) code receiver and transmitter, and methods for their operation in a 2D code communication system, are provided. The method for operating the 2D code receiver includes receiving a sequence of 2D codes from a 2D code transmitter having data encoded therein, wherein the 2D codes of the sequence are received in succession, and decoding the received a sequence of 2D codes into the data.

### CROSS-REFERENCE TO RELATED APPLICATION

This application claims the benefit under 35 U.S.C. §119(e) of a U.S. Provisional application filed on Apr. 24, 2009 in the U.S. Patent and Trademark Office and assigned Ser. No. 61/214,520, the entire disclosure of which is hereby incorporated by reference.

### BACKGROUND OF THE INVENTION

1. Field of the Invention

The present invention relates to data communication. More particularly, the present invention relates to data communication using Two-Dimensional (2D) bar codes.

2. Description of the Related Art

Two-Dimensional (2D) bar codes are fast gaining traction as enablers for online content and services. 2D bar codes encoded with information, such as a Uniform Resource Locator (URL), may appear in a magazine, on a sign, on a bus, on a business card or on any other object about which a user might desire to obtain information. To obtain information about an object with a 2D bar code disposed thereon, a user may use a device equipped with a camera and 2D bar code reader software. The device uses the camera to scan the image of the 2D bar code. The device then uses the 2D bar code reader software to decode the scanned 2D bar code to obtain the information encoded therein. For example, if the information is a URL, the URL may be used by an Internet browser to load a website corresponding to the URL that was encoded in the 2D bar code. The act of linking from a physical world object is referred to as a hardlink or a physical world hyperlink. Users may also generate and print their own 2D bar codes for others to scan.

Several 2D bar code symbologies have been standardized by the International Organization for Standardization (ISO) and the International Electrotechnical Commission (IEC). For example, the ISO/IEC 18004 standard specifies a 2D bar code symbology referred to as Quick Response (QR) code. An exemplary QR code will be described below with reference to FIG. 1.

FIG. 1 illustrates a structure of a conventional QR code.

Referring to FIG. 1, the QR code symbol is constructed of nominally square modules set out in a regular square array and each includes an encoding region and function patterns. The encoding region includes format information 102, version information 104, and data and error correction codewords 106. The function patterns include a finder pattern 112, a separator 114, timing patterns 116, and alignment patterns 118. Payload data is not encoded in the function patterns. The QR code symbol is surrounded on all four sides by a quiet zone 120.

QR codes come in a variety of sizes. For example, there are forty sizes of QR code symbols, which are referred to as Version 1, Version 2 . . . Version 40. Version 1 measures 21 modules×21 modules, Version 2 measures 25 modules×25 modules and so on increasing in steps of 4 modules per side up to Version 40 which measures 177 modules×177 modules. The QR code illustrated in FIG. 1 is an example of a Version 7 of a QR code symbol. A Version 1 of a QR code symbol is described below with reference to FIG. 2.

FIG. 2 illustrates a structure of a conventional Version 1 QR code symbol.

Referring to FIG. 2, the QR code is a Version 1 of a QR code symbol that measures 21 modules×21 modules. The data is encoded in 2×4 blocks 200 with each block carrying 8-bits of data, namely bits 0-7.

While a conventional 2D bar code communication system may be used to communicate limited amounts of information, the conventional 2D bar code communication system is not suitable for the transfer of large amounts of information.

Therefore, a need exists for an apparatus and method for transferring large amounts of information using 2D bar codes.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for data communication using Two-Dimensional (2D) bar codes.

In accordance with an aspect of the present invention, a method for operating a 2D code receiver in a 2D code communication system is provided. The method includes receiving a sequence of 2D codes from a 2D code transmitter having data encoded therein, wherein the 2D codes of the sequence are received in succession, and decoding the received sequence of 2D codes into the data.

In accordance with another aspect of the present invention, a method for operating a 2D code transmitter in a 2D code communication system is provided. The method includes encoding data into a sequence of 2D codes, and transmitting the sequence of 2D codes to a 2D code receiver, wherein the 2D codes of the sequence are transmitted in succession.

In accordance with yet another aspect of the present invention, a 2D code receiving apparatus for use in a 2D code communication system is provided. The apparatus includes a 2D code receiver for receiving a sequence of 2D codes from a 2D code transmitter having data encoded therein, wherein the 2D codes of the sequence are received in succession, and a processor for decoding the received sequence of 2D codes into the data.

In accordance with still another aspect of the present invention, a 2D code transmitting apparatus for use in a 2D code communication system is provided. The apparatus includes a processor for encoding data into a sequence of 2D codes, and a 2D code transmitter for transmitting the sequence of 2D codes to a 2D code receiver, wherein the 2D codes of the sequence are transmitted in succession.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a structure of a conventional QR code;

FIG. 2 illustrates a structure of a conventional Version 1 QR code symbol;

FIG. 3 illustrates 2D code communication in a 2D code communication system according to an exemplary embodiment of the present invention;

FIG. 4 illustrates a mapping of 2D codes for use in a 2D code communication system according to an exemplary embodiment of the present invention;

FIG. 5 illustrates bidirectional 2D code communication in a 2D code communication system according to an exemplary embodiment of the present invention;

FIG. 6 is a flowchart illustrating a method for receiving 2D codes at a 2D code receiver in a 2D code communication system according to an exemplary embodiment of the present invention;

FIG. 7 illustrates synchronization of a 2D code receiver to a 2D code transmitter in a 2D code communication system according to an exemplary embodiment of the present invention;

FIG. 8 illustrates a 2D code used for synchronization of a 2D code receiver to a 2D code transmitter in a 2D code communication system according to an exemplary embodiment of the present invention;

FIG. 9 illustrates a 2D code sequence used for synchronization of a 2D code receiver to a 2D code transmitter in a 2D code communication system according to an exemplary embodiment of the present invention;

FIG. 10 illustrates a 2D code sequence used for synchronization of a 2D code receiver to a 2D code transmitter in a 2D code communication system according to an exemplary embodiment of the present invention;

FIG. 11 illustrates a 2D code sequence used for synchronization of a 2D code receiver to a 2D code transmitter in a 2D code communication system according to an exemplary embodiment of the present invention;

FIG. 12 is a signal diagram for determining a supported code resolution in a 2D code communication system according to an exemplary embodiment of the present invention;

FIG. 13 is a flowchart illustrating a method for receiving 2D codes at a 2D code receiver based on a supported code resolution in a 2D code communication system according to an exemplary embodiment of the present invention;

FIG. 14 is a signal diagram for an ARQ operation in a 2D code communication system according to an exemplary embodiment of the present invention;

FIG. 15 illustrates a mapping of 2D sub-codes for use in a 2D code communication system according to an exemplary embodiment of the present invention;

FIG. 16 is a signal diagram for an ARQ operation in a 2D code communication system according to an exemplary embodiment of the present invention;

FIG. 17 illustrates point-to-multipoint 2D code communication in a 2D code communication system according to an exemplary embodiment of the present invention;

FIG. 18 illustrates a structure of a color 2D code for use in a 2D code communication system according to an exemplary embodiment of the present invention;

FIGS. 19A and 19B illustrate structures of 2D codes including interleaved error correction bits for use in a 2D code communication system according to an exemplary embodiment of the present invention; and

FIG. 20 illustrates multipoint-to-point 2D code communication in a 2D code communication system according to an exemplary embodiment of the present invention.

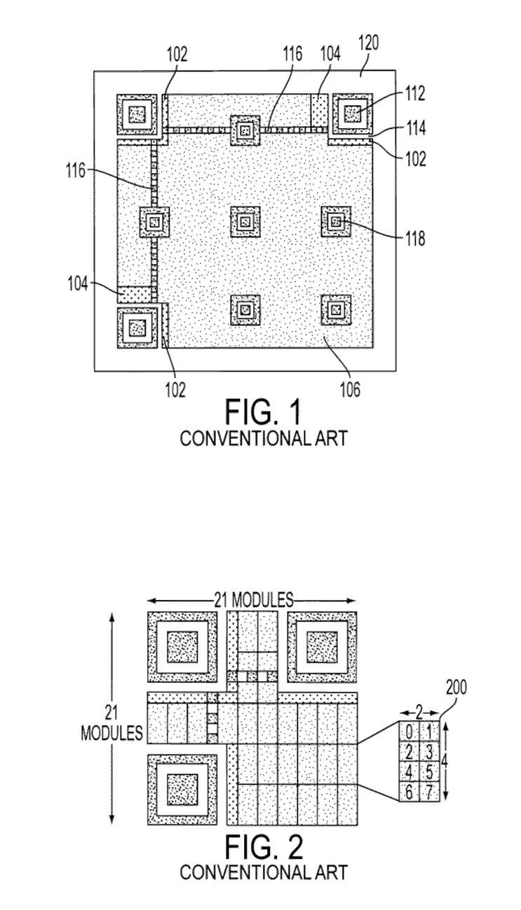

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to data communication using Two-Dimensional (2D) bar codes (hereafter referred to as 2D codes). Quick Response (QR) codes may be described below as an example of 2D codes. However, the present invention is not limited to QR codes as it is can equally apply to other types of 2D codes.

It should be understood that the following description may refer to terms utilized in various standards merely for simplicity of explanation. For example, the following description may refer to terms utilized in an Open Mobile Alliance (OMA) Mobile Codes standard as well as an Institute of Electrical and Electronics Engineers (IEEE) 802.15 TG7 visible-light communication standard. However, this description should not be interpreted as being limited to such standards. Independent of the mechanism used for data communication using 2D codes, it is preferable to communicate data using 2D codes and it is advantageous for that ability to conform to a standardized mechanism.

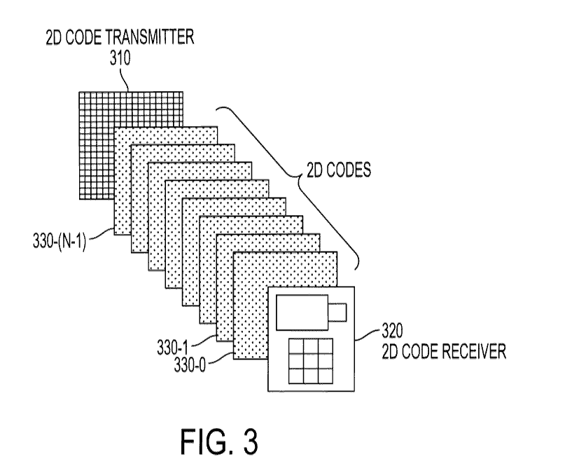

FIG. 3 illustrates 2D code communication in a 2D code communication system according to an exemplary embodiment of the present invention.

Referring to FIG. 3, data is communicated from a 2D code transmitter 310 to a 2D code receiver 320. More specifically, the data is encoded into the 2D codes 330-0 to 330-(N-1). The 2D codes 330-0 to 330-(N-1) may be QR codes. The 2D codes 330-0 to 330-(N-1) are transmitted by the 2D code transmitter 310 in sequence to the 2D code receiver 320.

The 2D code transmitter 310 may be a display or any other apparatus capable of producing 2D codes in sequence. If the 2D code transmitter 310 is a display, the display may utilize a display unit such as a Cathode Ray Tube (CRT), plasma display, Liquid Crystal Display (LCD), Organic Light Emitting Diode (OLED) or any other type of display. In this case, the display may include a controller for controlling the display unit, a video memory in which image data is stored and the display unit. Further, the display may be a projected image.

The 2D receiver 320 may be a camera or any other apparatus capable of reading 2D codes in sequence. If the 2D receiver 320 is a camera, the camera captures an image of the 2D codes through a lens. Herein, the camera includes a camera sensor for converting a captured optical signal to an electrical signal and a signal processor for converting an analog video signal received from the camera sensor to digital data. The camera sensor may be a Charge Coupled Device (CCD) sensor or a Complementary Metal-Oxide Semiconductor (CMOS) sensor, and the signal processor may be a Digital Signal Processor (DSP), to which the present invention is not limited.

All or a portion of the actions of the 2D code transmitter described herein may be performed by or under the control of a processor associated there with. Similarly, all or a portion of the actions of the 2D code receiver described herein may be performed by or under the control of a processor there with.

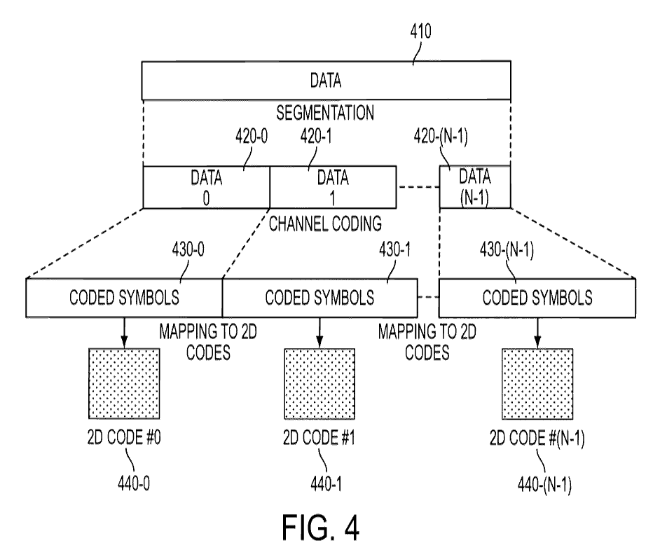

An exemplary encoding of the data into the 2D codes 330-0 to 330-(N-1) is described in more detail below with reference to FIG. 4.

FIG. 4 illustrates a mapping of 2D codes for use in a 2D code communication system according to an exemplary embodiment of the present invention.

Referring to FIG. 4, data 410 to be transmitted by a 2D code transmitter is segmented into data blocks 420-0 to 420-(N-1). A channel coding process is performed on the data blocks 420-0 to 420-(N-1), which generates coded symbols 430-0 to 430-(N-1). The coded symbols 430-0 to 430-(N-1) are mapped to 2D codes 440-0 to 440-(N-1). The segmenting, channel coding, and mapping may be performed by any combination of one or more of a processor associated with the 2D code transmitter, a data segmentor, a channel coder, and a 2D code mapper. When transmitted by the 2D code transmitter, the 2D codes 440-0 to 440-(N-1) are serially transmitted at a certain frequency, which may be referred to as a code switching rate. If the 2D code transmitter is a display, such as the display described above, the code switching rate may correspond to a refresh rate of the display. To receive the 2D codes 440-0 to 440-(N-1), the 2D code receiver synchronizes with the 2D code transmitter's code switching rate to properly receive each 2D code. The synchronizing with the 2D code transmitter may be performed by any combination of one or more of a processor associated with the 2D code receiver and a synchronization unit. The 2D code receiver extracts data encoded in each of the received 2D codes 440-0 to 440-(N-1), performs reassembly of the data 410, and delivers the data 410 to higher protocol layers. More specifically, the 2D code receiver demaps the received 2D codes 440-0 to 440-(N-1) back into the coded symbols 430-0 to 430-(N-1). The 2D code receiver then channel decodes the coded symbols 430-0 to 430-(N-1) back into the data blocks 420-0 to 420-(N-1), which are then reassembled into the data for delivery to higher protocol layers. The demapping, channel decoding, and reassembly may be performed by any combination of one or more of a processor associated with the 2D code receiver, a 2D code demapper, a channel decoder, and a data assembly unit.

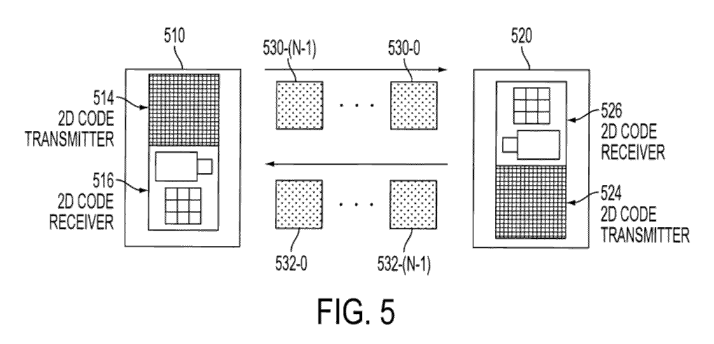

Up to this point, unidirectional 2D code communication has been described. However, according to an exemplary embodiment of the present invention, 2D code communication between two devices may be bi-directional. An example of Bi-directional 2D code communication will be described below with reference to FIG. 5.

FIG. 5 illustrates bi-directional 2D code communication in a 2D code communication system according to an exemplary embodiment of the present invention.

Referring to FIG. 5, data is bi-directionally communicated between two devices 510 and 520. Device 510 includes a 2D code transmitter 514, a 2D code receiver 516, and a processor (not shown). Similarly, device 520 includes a 2D code transmitter 524, a 2D code receiver 526, and a processor (not shown). The 2D code transmitters 514 and 524 may be a display, such as the display described above, or any other apparatus capable of producing 2D codes. Also, the 2D code receivers 516 and 526 may be a camera, such as the camera described above, or any other apparatus capable of reading 2D codes.

Data communicated from device 510 to device 520 is communicated using 2D codes 530-0 to 530-(N-1). More specifically, the 2D code transmitter 514 of device 510 transmits the 2D codes 530-0 to 530-(N-1), which are received by the 2D code receiver 526 of device 520. The 2D codes 530-0 to 530-(N-1) may be transmitted by the 2D code transmitter 514 of device 510 in sequence to the 2D code receiver 526 of device 520. The 2D codes 530-0 to 530-(N-1) may be QR codes. The 2D codes 530-0 to 530-(N-1) are encoded with the data being communicated.

Data communicated from device 520 to 510 is communicated using 2D codes 532-0 to 532-(N-1). More specifically, the 2D code transmitter 524 of device 520 is used to transmit the 2D codes 532-0 to 532-(N-1), which are received by the 2D code receiver 516 of device 510. The 2D codes 532-0 to 532-(N-1) may be transmitted by the 2D code transmitter 524 of device 520 in sequence to the 2D code receiver 516 of device 510. The 2D codes 532-0 to 532-(N-1) may be QR codes. The 2D codes 532-0 to 532-(N-1) are encoded with the data being communicated.

Bi-directional 2D code communication is advantageous in that the bi-directional communication allows a 2D code receiver to provide control information feedback to a 2D code transmitter. To facilitate control information feedback, a 2D code may carry data information, control information or both. For example, when device 510 provides control feedback to device 520, device 510 may also encode data to be transmitted to device 510 in the same 2D code used for carrying control feedback.

In addition, bi-directional 2D code data communication is advantageous in that the bi-directional 2D code communication allows for simultaneous 2-way communication of data via 2D codes. Exemplary applications that would benefit from implementing bi-directional 2D code communication include instant messaging and interactive multi-person gaming. While bi-directional 2D code data communication has been described above, in an exemplary embodiment of the present invention, one the two directions of communication may be implemented using a type of communication other than 2D code communication, such as infrared communication, radio frequency communication, etc.

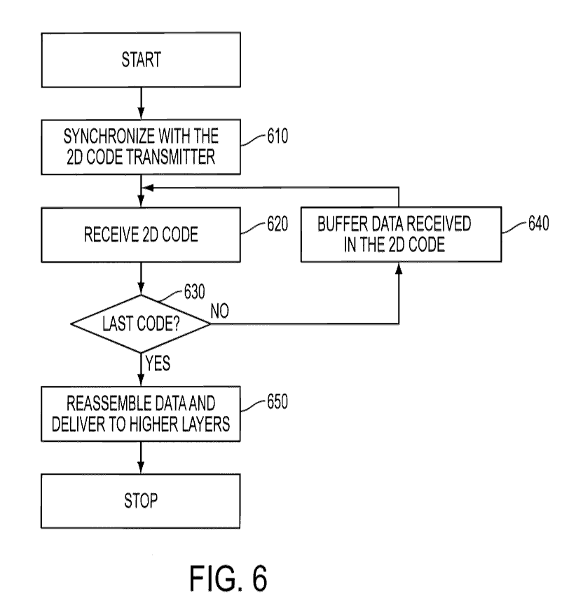

An exemplary method for receiving 2D codes at a 2D code receiver in a 2D code communication system is described below with reference to FIG. 6.

FIG. 6 is a flowchart illustrating a method for receiving 2D codes at a 2D code receiver in a 2D code communication system according to an exemplary embodiment of the present invention.

Referring to FIG. 6, in step 610, a 2D code receiver synchronizes to a 2D code transmitter. Herein, the 2D code receiver synchronizes to a 2D code transmission frequency of the 2D code transmitter. The synchronizing of the 2D code receiver with the 2D code transmitter may be performed by any combination of one or more of a processor associated with the 2D code receiver and a synchronization unit. In step 620, the 2D code receiver receives a 2D code transmitted by the 2D code transmitter. In step 630, the 2D code receiver determines if the 2D code received from the 2D code transmitter is the last 2D code of a sequence of 2D codes transmitted by the 2D code transmitter. If the 2D code received from the 2D code transmitter is not the last 2D code, in step 640, the 2D code receiver buffers the data received in the 2D code and returns to step 620. However, if the 2D code received from the 2D code transmitter is the last 2D code, in step 650, the 2D code receiver decodes the data as described above and delivers the data to a higher layer. Thereafter, the process of receiving 2D codes at a 2D code receiver ends.

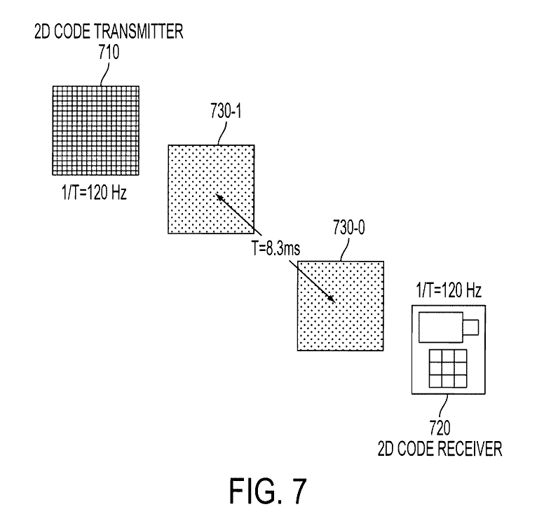

An example of the synchronization process of step 610 is described in more detail below with reference to FIG. 7.

FIG. 7 illustrates synchronization of a 2D code receiver to a 2D code transmitter in a 2D code communication system according to an exemplary embodiment of the present invention.

Referring to FIG. 7, 2D codes 730-0 and 730-1 are communicated from a 2D code transmitter 710 to a 2D code receiver 720 at a 2D code transmission frequency, which is referred to as a code switching rate. The 2D code receiver 720 determines the code switching rate of the 2D codes 730-0 and 730-1 communicated from the 2D code transmitter 710. In this example the code switching rate (1/T) is 120 Hz. Therefore, the transmission time between 2D codes 730-0 and 730-1 is T=8.3 ms. Assuming a real-time processing of the 2D codes, the 2D code receiver needs to process each received 2D code within 8.3 ms. When the 2D code transmitter is a display, the code transmission rate may be determined by a refresh rate of the display. In cases where processing capabilities of the 2D code receiver are limited, the 2D code receiver may buffer the received 2D codes for processing at a later time. The synchronizing of the 2D code receiver with the 2D code transmitter may be performed by any combination of one or more of a processor associated with the 2D code receiver and a synchronization unit.

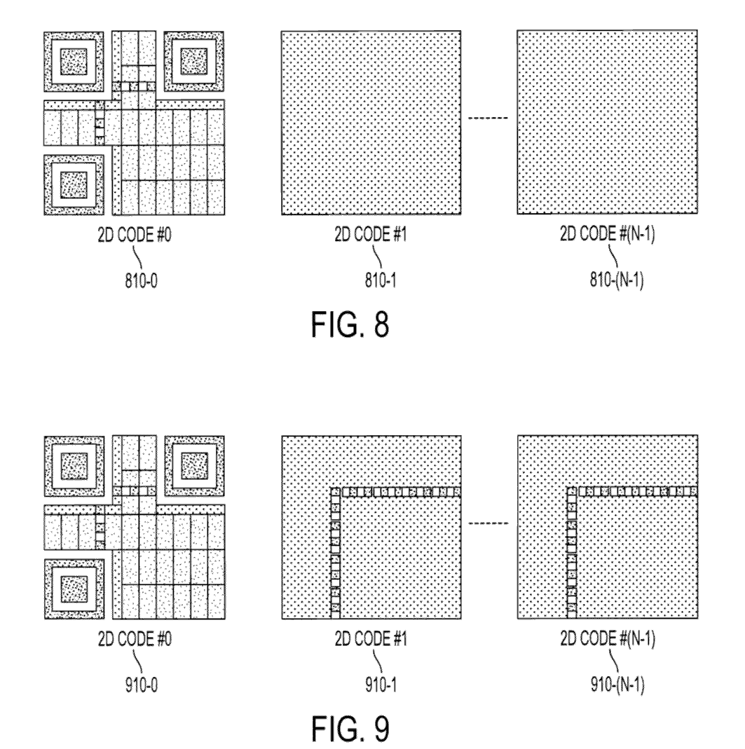

In exemplary embodiments of the present invention, the 2D codes transmitted by the 2D code transmitter may include features that assist the 2D code receiver in synchronizing with the 2D code transmitter. Exemplary implementations of the features in the 2D codes that assist the 2D code receiver in synchronizing with the 2D code transmitter are described below with reference to FIGS. 8-11.

FIG. 8 illustrates a 2D code used for synchronization of a 2D code receiver to a 2D code transmitter in a 2D code communication system according to an exemplary embodiment of the present invention.

Referring to FIG. 8, a sequence of 2D codes 810-0 to 810-(N-1) are communicated from a 2D code transmitter to a 2D code receiver. The first 2D code 810-0 transmitted by the 2D code transmitter includes all of the functional fields to assist the 2D code receiver in synchronizing with the 2D code transmitter. The remaining 2D codes 810-1 to 810-(N-1) may omit part or all of the functional fields and the timing pattern in order to encode more data bits in those 2D codes.

FIG. 9 illustrates a 2D code sequence used for synchronization of a 2D code receiver to a 2D code transmitter in a 2D code communication system according to an exemplary embodiment of the present invention.

Referring to FIG. 9, a sequence of 2D codes 910-0 to 910-(N-1) are communicated from a 2D code transmitter to a 2D code receiver. The first code 910-0 includes all of the functional fields, but the remaining 2D codes 910-1 to 910-(N-1) only contain the timing pattern and data fields.

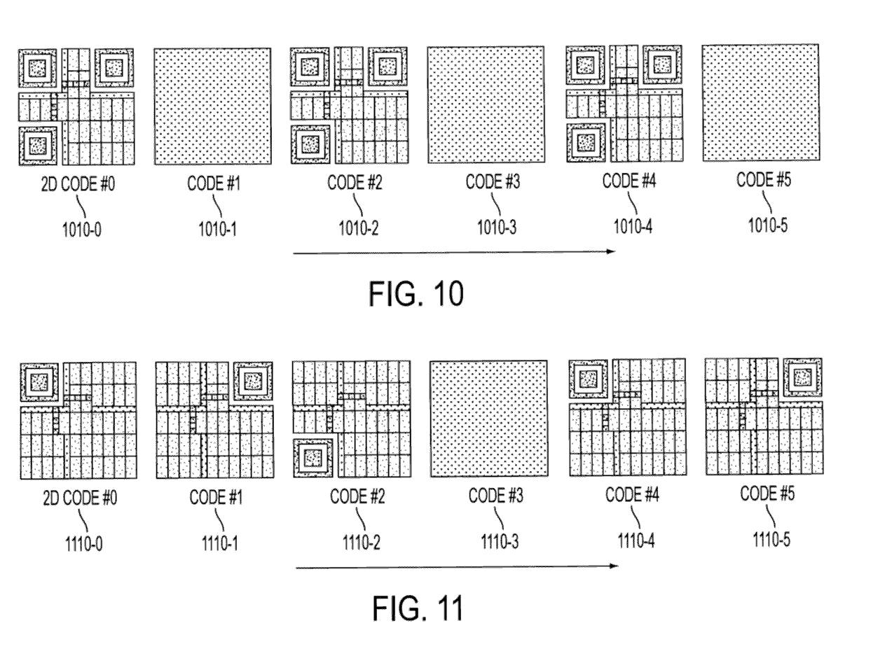

FIG. 10 illustrates a 2D code sequence used for synchronization of a 2D code receiver to a 2D code transmitter in a 2D code communication system according to an exemplary embodiment of the present invention.

Referring to FIG. 10, a sequence of 2D codes 1010-0 to 1010-5 are communicated from a 2D code transmitter to a 2D code receiver. 2D codes 1010-0, 1010-2, and 1010-4 containing all of the functional fields are interspersed among 2D codes 1010-1, 1010-3, and 1010-5 that only contain data. The transmission of codes 1010-0, 1010-2, and 1010-4 containing all of the functional fields allows the 2D code receiver to maintain synchronization with the 2D code transmitter.

FIG. 11 illustrates a 2D code sequence used for synchronization of a 2D code receiver to a 2D code transmitter in a 2D code communication system according to an exemplary embodiment of the present invention.

Referring to FIG. 11, a sequence of 2D codes 1110-0 to 1110-5 are communicated from a 2D code transmitter to a 2D code receiver. The functional fields may be carried over multiple 2D codes. For example, the finder pattern may be carried over a number of 2D codes. In the exemplary implementation illustrated in FIG. 11, the finder pattern is carried over three 2D codes 1110-0, 1110-1, and 1110-2, skips one 2D code 1110-3, and begins again in 2D codes 1110-4. Some of the 2D codes may have a reduced set of functional fields or no functional fields. The sequence in which 2D codes appear with partial functional fields may be pre-known at the 2D code receiver.

As described above with reference to FIGS. 8-11, various features may be implemented in the 2D codes transmitted by the 2D code transmitter to assist the 2D code receiver in synchronizing with the 2D code transmitter.

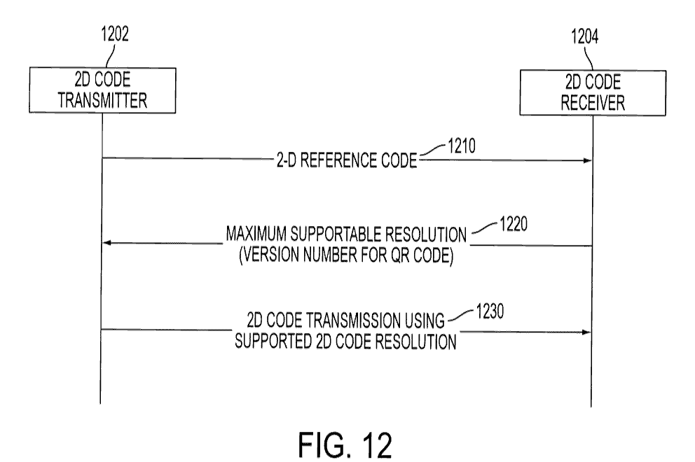

In an exemplary embodiment of the present invention, in addition to the 2D codes employing features that assist in synchronization, the same 2D codes may be used by the 2D code receiver for determining a supported code resolution. An exemplary implementation of using 2D codes to assist the 2D code receiver in determining the supported code resolution is described below with reference to FIG. 12.

FIG. 12 is a signal diagram for determining a supported code resolution in a 2D code communication system according to an exemplary embodiment of the present invention.

Referring to FIG. 12, a 2D code transmitter 1202 transmits a reference 2D code to a 2D code receiver 1204 in step 1210. The transmission of one reference 2D code is described herein as an example. In an exemplary implementation, a plurality of reference 2D codes may be transmitted. The reference 2D code may include functional fields, such as the codes described above with respect to FIGS. 8-11. The reference 2D code may be the same 2D code used by the 2D code receiver to synchronize to a 2D code transmitter. Alternatively, the reference 2D code may be a different 2D code than the 2D code used by the 2D code receiver to synchronize to a 2D code transmitter. The 2D code receiver 1204 determines from the received reference 2D code a supportable resolution. The determined supportable resolution may be one or more of a maximum supportable resolution, a minimum supportable resolution, or a range of supportable resolutions. The determined supportable resolution may be based on one or more of the capabilities of the camera, processing speed, transmission rate of the 2D codes, etc. Further, when the 2D codes are QR codes, the determined supportable resolution may correspond to a code version. Here, codes with higher resolution or higher version numbers can carry more data bits compared to codes with lower resolution or version number. The determining of the supportable resolution may be performed by any combination of one or more of a processor associated with the 2D code receiver and a supportable resolution determiner. In addition to determining a supportable resolution, a supportable transmission rate may also be determined. The determining of the transmission rate may be performed by any combination of one or more of a processor associated with the 2D code receiver, a supportable resolution determiner, and a supportable transmission rate determiner.

After the supportable resolution is determined, the 2D code receiver 1204 transmits the determined supportable resolution (or version number) to the 2D code transmitter 1202 in step 1220. The transmitted determined supportable resolution may additionally include supportable transmission rate information. The 2D code transmitter 1202 then transmits 2D codes to the 2D code receiver 1204 in step 1230 based on the supportable resolution reported by the 2D code receiver.

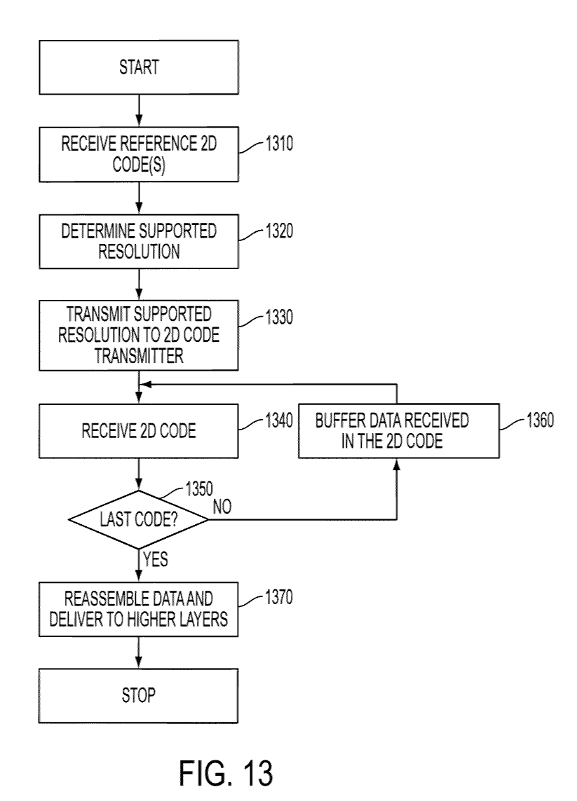

An exemplary method for receiving 2D codes based on a supported code resolution is described below with reference to FIG. 13.

FIG. 13 is a flowchart illustrating a method for receiving 2D codes at a 2D code receiver based on a supported code resolution in a 2D code communication system according to an exemplary embodiment of the present invention.

Referring to FIG. 13, in step 1310, a 2D code receiver receives a reference 2D code. The transmission of one reference 2D code is described herein as an example. In an exemplary implementation, a plurality of reference 2D codes may be transmitted. The reference 2D code may include functional fields, such as the codes described above with respect to FIGS. 8-11. The reference 2D code may be the same 2D code used by the 2D code receiver to synchronize to a 2D code transmitter. Alternatively, the reference 2D code may be a different 2D code than the 2D code used by the 2D code receiver to synchronize to a 2D code transmitter. In step 1320, the 2D code receiver determines from the received reference 2D code a supportable resolution. The determined supportable resolution may be one or more of a maximum supportable resolution, a minimum supportable resolution, or a range of supportable resolutions. The determined supportable resolution may be based on one or more of the capabilities of a camera, a rate at which the 2D receiver can detect and/or decode 2D codes, a transmission rate of the 2D codes, etc. Further, when the 2D codes are QR codes, the determined supportable resolution may correspond to a code version. Here, codes with higher resolution or higher version numbers can carry more data bits compared to codes with lower resolution or version number. In addition to determining a supportable resolution, a supportable transmission rate may also be determined. After the supportable resolution is determined, in step 1330, the 2D code receiver transmits the determined supportable resolution (or version number) to the 2D code transmitter. The transmitted determined supportable resolution may additionally include supportable transmission rate information. In step 1340, a 2D code, based on the supportable resolution, is received by the 2D code receiver. In step 1350, the 2D code receiver determines if the 2D code received from the 2D code transmitter is the last 2D code of a sequence of 2D codes transmitted by the 2D code transmitter. If the 2D code received from the 2D code transmitter is not the last 2D code, in step 1360, the 2D code receiver buffers the data received in the 2D code and returns to step 1340. However, if the 2D code received from the 2D code transmitter is the last 2D code, in step 1370, the 2D code receiver reassembles the data and delivers the data to a higher layer. Thereafter, the process of receiving 2D codes at a 2D code receiver ends.

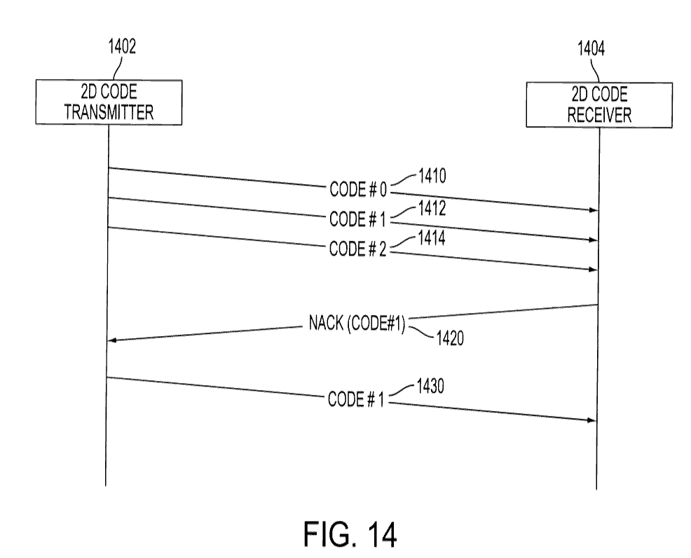

While 2D codes are normally communicated without error, it may be possible that a 2D code received at a 2D code receiver may not be successfully decoded. Here, the error may be caused by any number of circumstances. In order to address this scenario, an Automatic Repeat reQuest (ARQ) transmission method may be used to ensure reliable data transmission. An exemplary ARQ transmission method for communicating data using 2D codes is described below with reference to FIG. 14.

FIG. 14 is a signal diagram for an ARQ operation in a 2D code communication system according to an exemplary embodiment of the present invention.

Referring to FIG. 14, a sequence of 2D codes including Code #0, Code #1 and Code #2 are transmitted from a 2D code transmitter 1402 to a 2D code receiver 1404 in steps 1410, 1412, and 1414. After receiving the 2D code sequence, the 2D code receiver 1404 determines if any of the 2D codes have not been successfully decoded. Assuming that Code #1 has not been successfully decoded, the 2D code receiver 1404 determines that the Code #1 has not been successfully decoded, and generates and sends a Negative ACknowledgement (NACK) in step 1420 to the 2D code transmitter 1402 that identifies Code #1. Upon receiving the NACK from the 2D code receiver 1404, the 2D code transmitter 1402 determines that Code #1 should be retransmitted to the 2D code receiver 1404, and retransmits Code #1 in step 1430.

The determining, by the 2D code receiver 1404, if any of the 2D codes have not been successfully decoded may be performed by any combination of one or more of a processor associated with the 2D code receiver 1404 and a successful decoding determiner. The generation, by the 2D code receiver 1404, of the NACK may be performed by any combination of one or more of a processor associated with the 2D code receiver 1404, the successful decoding determiner, and a NACK generator.

The determining, by the 2D code transmitter 1402, if any of the 2D codes should be retransmitted may be performed by any combination of one or more of a processor associated with the 2D code transmitter 1402 and a 2D code retransmission determiner.

While the NACK described above only indentifies one 2D code, it may identify any number of 2D codes that have not been successfully decoded. Alternatively, a separate NACK may be generated and transmitted for each 2D code or a subset of the 2D codes that have not been successfully decoded.

While it is described above that the 2D code receiver 1404 determines if any of the 2D codes have not been successfully decoded after all 2D codes of a 2D code sequence have been received, in an another exemplary embodiment, the 2D code receiver 1404 may determine if a 2D code has not been successfully decoded after each 2D code is transmitted. In this case, the 2D code receiver 1404 may transmit the NACK as described above, or may alternatively, transmit a NACK after any 2D code has not been successfully decoded.

The 2D code transmitter 1402 may retransmit the one or more 2D codes identified in a NACK upon receipt of the NACK, even if the retransmission of the one or more 2D codes occurs within the transmission of a sequence of 2D codes. Alternatively, the 2D code transmitter 1402 may retransmit the one or more 2D codes after any transmission of a sequence of 2D codes. When more than one NACK is received, the 2D code transmitter 1402 may retransmit the one or more 2D codes identified in the NACKs in an order based on the order of receipt of the NACKs. The order may be First-In-First-Out (FIFO), Last-In-First-Out (LIFO), or any other order.

Alternatively, instead of using a NACK, a 2D code communication system according to an exemplary embodiment of the present invention, may employ an ACknowledgement (ACK) scheme. The ACK scheme is similar to the NACK scheme described above, except that an ACK identifies one or more successfully decoded 2D codes instead of the identification of one or more unsuccessfully decoded 2D codes that is employed in the NACK scheme. In the ACK scheme, 2D codes are retransmitted by the 2D code transmitter 1402 based on the lack of receipt of an ACK from the 2D code receiver 1404. Here, the determining, by the 2D code receiver 1404, if any of the 2D codes have been successfully decoded may be performed by any combination of one or more of a processor associated with the 2D code receiver 1404 and a successful decoding determiner. The generation, by the 2D code receiver 1404, of the ACK may be performed by any combination of one or more of a processor associated with the 2D code receiver 1404, the successful decoding determiner, and an ACK generator. The determining, by the 2D code transmitter 1402, if any of the 2D codes should be retransmitted may be performed by any combination of one or more of a processor associated with the 2D code transmitter 1402 and a 2D code retransmission determiner.

As described above, the 2D code receiver 1404 provides feedback on the codes that need to be retransmitted. In this exemplary embodiment, it is assumed that there is a reverse channel from the 2D code receiver 1404 to the 2D code transmitter 1402. The communication on this reverse channel may use 2D code communication or any other type of communication, such as infrared communication, radio frequency communication, etc.

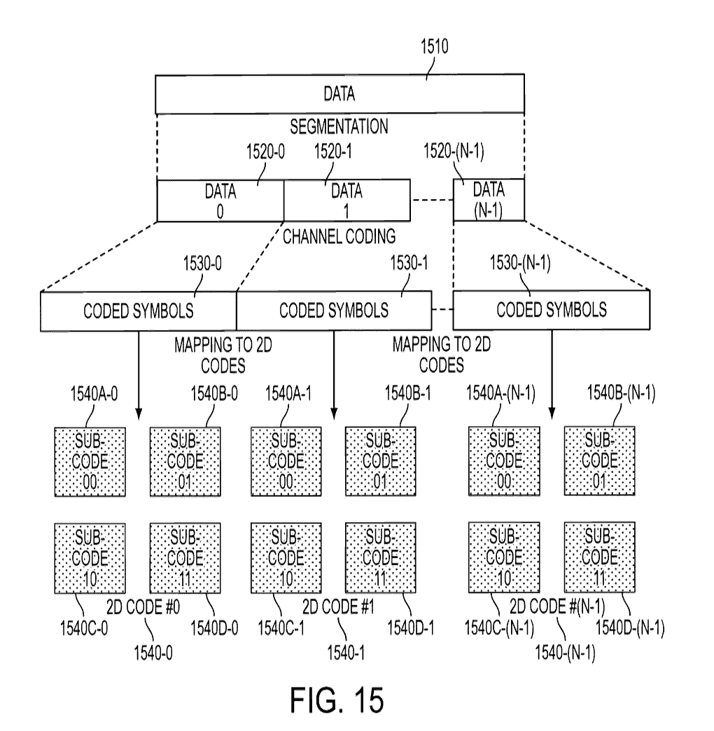

Another exemplary technique to ensure reliable data transmission in a 2D code communication system is to provide redundancy in the transmitted 2D codes. The addition of redundancy to the transmitted 2D codes is described below with reference to FIG. 15.

FIG. 15 illustrates a mapping of 2D sub-codes for use in a 2D code communication system according to an exemplary embodiment of the present invention.

Referring to FIG. 15, data 1510 to be transmitted by a 2D code transmitter is segmented into data blocks 1520-0 to 1520-(N-1). A channel coding process is performed on the data blocks 1520-0 to 1520-(N-1), which generates coded symbols 1530-0 to 1530-(N-1). The coded symbols 1530-0 to 1530-(N-1) are mapped to 2D codes 1540-0 to 1540-(N-1). Each of the 2D codes 1540-0 to 1540-(N-1) comprises four 2D sub-codes. More specifically, 2D code 1540-0 comprises 2D sub-codes 1540A-0, 1540B-0, 1540C-0, and 1540D-0; 2D code 1540-1 comprises 2D sub-codes 1540A-1, 1540B-1, 1540C-1, and 1540D-1; and 2D code 1540-(N-1) comprises 2D sub-codes 1540A-(N-1), 1540B-(N-1), 1540C-(N-1), and 1540D-(N-1). The use of four sub-codes for each 2D code is merely an example, as any number of sub-codes may be employed. The segmenting, channel coding, and mapping may be performed by any combination of one or more of a processor associated with the 2D code transmitter, a data segmentor, a channel coder, a 2D code mapper, and a 2D sub-code mapper.

In one exemplary embodiment, when mapping the coded symbols 1530-0 to 1530-(N-1) to the 2D codes 1540-0 to 1540-(N-1), each coded symbol is mapped over the four sub-codes of each 2D code.

In another exemplary embodiment, each of the four sub-codes of each 2D code comprises substantially identical information, thereby providing redundancy in the transmitted 2D codes. In this case, a 2D code receiver need only be able to successfully decode one of the 2D sub-codes of a 2D code in order to receive the 2D code without error.

In one exemplary embodiment, the four sub-codes of a 2D code are simultaneously transmitted to the 2D code receiver. In this exemplary embodiment, each the 2D codes 1540-0 to 1540-(N-1) are serially transmitted at a code switching rate. To receive the 2D codes 1540-0 to 1540-(N-1), the 2D code receiver synchronizes with the 2D code transmitter's code switching rate to properly receive each 2D code. The synchronizing with the 2D code transmitter may be performed by any combination of one or more of a processor associated with the 2D code receiver and a synchronization unit. The 2D code receiver extracts data encoded in each of the 2D sub-codes of a received 2D code. When the sub-codes comprise redundant information, a 2D code receiver need only be able to successfully decode one of the 2D sub-codes of a 2D code in order to receive the 2D code without error. If the information of the 2D code is spread over the 2D sub-codes, a 2D code receiver needs to be able to successfully decode all of the 2D sub-codes of a 2D code in order to receive the 2D code without error. After all of the 2D codes are decoded, the 2D code receiver performs reassembly of the data 1510, and delivers the data 1510 to higher protocol layers.

In another exemplary embodiment, the four sub-codes of a 2D code are serially transmitted by the 2D code transmitter to the 2D code receiver. In this exemplary embodiment, each the 2D sub-codes are serially transmitted at a certain frequency, which may be referred to as a sub-code switching rate. To receive the 2D codes 1540-0 to 1540-(N-1), the 2D code receiver synchronizes with the 2D code transmitter's sub-code switching rate to properly receive the sub-codes for each 2D code. The synchronizing with the 2D code transmitter may be performed by any combination of one or more of a processor associated with the 2D code receiver and a synchronization unit. The 2D code receiver extracts data encoded in each of the 2D sub-codes of a received 2D code. When the sub-codes comprise redundant information, a 2D code receiver need only be able to successfully decode one of the 2D sub-codes of a 2D code in order to receive the 2D code without error. If the information of the 2D code is spread over the 2D sub-codes, a 2D code receiver needs to be able to successfully decode all of the 2D sub-codes of a 2D code in order to receive the 2D code without error. After all of the 2D codes are decoded, the 2D code receiver performs reassembly of the data 1510, and delivers the data 1510 to higher protocol layers.

The decoding and reassembly of the data 1510 may be performed by any combination of one or more of a processor associated with the 2D code receiver, a 2D sub-code demapper, a 2D code demapper, a channel decoder, and a data assembly unit.

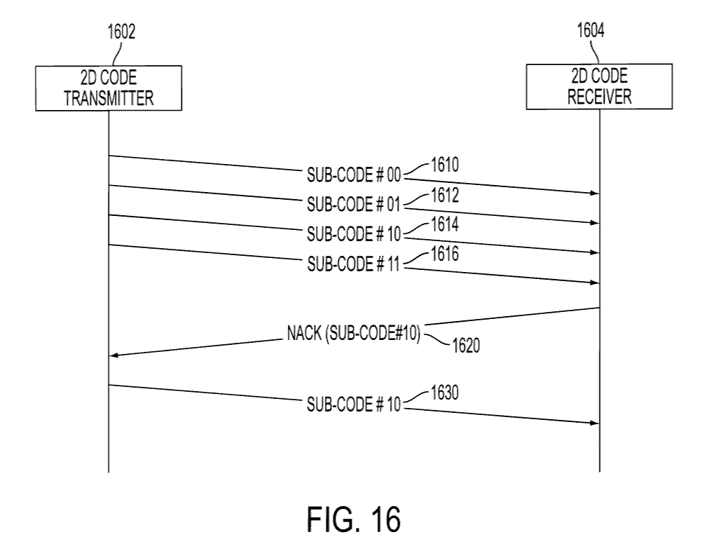

The implementation of 2D sub-codes may advantageously employ ARQ to provide feedback on a 2D sub-code basis. An exemplary ARQ operation for use with 2D sub-codes is described below with reference to FIG. 16.

FIG. 16 is a signal diagram for an ARQ operation in a 2D code communication system according to an exemplary embodiment of the present invention.

Referring to FIG. 16, a 2D code including Sub-code #00, Sub-code #01, Sub-code #10 and Sub-code #11 is transmitted from a 2D code transmitter 1602 to a 2D code receiver 1604 in steps 1610, 1612, 1614, and 1616. After receiving the 2D sub-codes, the 2D code receiver 1604 determines if any of the 2D sub-codes have not been successfully decoded. Assuming that Sub-code #10 has not been successfully decoded, the 2D code receiver 1604 determines that the Sub-code #10 has not been successfully decoded, and generates and sends a NACK in step 1620 to the 2D code transmitter 1602 that identifies Sub-code #10. Upon receiving the NACK from the 2D code receiver 1604, the 2D code transmitter 1602 determines that Sub-code #10 should be retransmitted to the 2D code receiver 1604, and retransmits Sub-code #10 in step 1630.

The determining, by the 2D code receiver 1604, if any of the 2D Sub-codes have not been successfully decoded may be performed by any combination of one or more of a processor associated with the 2D code receiver 1604 and a successful decoding determiner. The generation, by the 2D code receiver 1604, of the NACK may be performed by any combination of one or more of a processor associated with the 2D code receiver 1604, the successful decoding determiner, and a NACK generator.

The determining, by the 2D code transmitter 1602, if any of the 2D codes should be retransmitted may be performed by any combination of one or more of a processor associated with the 2D code transmitter 1602 and a 2D code retransmission determiner.

While the NACK described above only indentifies one 2D sub-code, it may identify any number of 2D sub-codes that have not been successfully decoded. Alternatively, a separate NACK may be generated and transmitted for each 2D sub-code or a subset of the 2D sub-codes that have not been successfully decoded.

While it is described above that the 2D code receiver 1604 determines if any of the 2D sub-codes have not been successfully decoded after all 2D sub-codes of a 2D code have been received, in an another exemplary embodiment, the 2D code receiver 1604 may determine if a 2D sub-code has not been successfully decoded after reception of each 2D sub-code. In this case, the 2D sub-code receiver 1604 may transmit the NACK as described above, or may alternatively, transmit a NACK after any 2D sub-code has not been successfully decoded.

The 2D code transmitter 1602 may retransmit the one or more 2D sub-codes identified in a NACK upon receipt of the NACK, even if the retransmission of the one or more 2D sub-codes occurs within the transmission of other 2D sub-codes of a 2D code. Alternatively, the 2D code transmitter 1602 may retransmit the one or more 2D sub-codes after any transmission of 2D sub-codes of a 2D code. When more than one NACK is received, the 2D code transmitter 1602 may retransmit the one or more 2D sub-codes identified in the NACKs in an order based on the order of receipt of the NACKs. The order may be First-In-First-Out (FIFO), Last-In-First-Out (LIFO), or any other order.

While an ARQ operation for a serial transmission of sub-codes has been described above, the ARQ operation similarly applies when sub-codes are simultaneously transmitted. In this case, the 2D sub-codes are simultaneously transmitted and a NACK, if any, is transmitted thereafter.

In addition, instead of using a NACK, a 2D code communication system according to an exemplary embodiment of the present invention, may employ an ACK scheme. The ACK scheme is similar to the NACK scheme described above, except that an ACK identifies one or more successfully decoded 2D sub-codes instead of the identification of one or more unsuccessfully decoded 2D sub-codes that is employed in the NACK scheme. In the ACK scheme, 2D sub-codes are retransmitted by the 2D code transmitter 1602 based on the lack of receipt of an ACK from the 2D code receiver 1604. Here, the determining, by the 2D code receiver 1604, if any of the 2D codes have been successfully decoded may be performed by any combination of one or more of a processor associated with the 2D code receiver 1604 and a successful decoding determiner. The generation, by the 2D code receiver 1604, of the ACK may be performed by any combination of one or more of a processor associated with the 2D code receiver 1604, the successful decoding determiner, and an ACK generator. The determining, by the 2D code transmitter 1602, if any of the 2D codes should be retransmitted may be performed by any combination of one or more of a processor associated with the 2D code transmitter 1602 and a 2D code retransmission determiner.

As described above, the 2D code receiver 1604 provides feedback on the sub-codes that need to be retransmitted. In this exemplary embodiment, it is assumed that there is a reverse channel from the 2D code receiver 1604 to the 2D code transmitter 1602. The communication on this reverse channel may use 2D code communication or any other communication media.

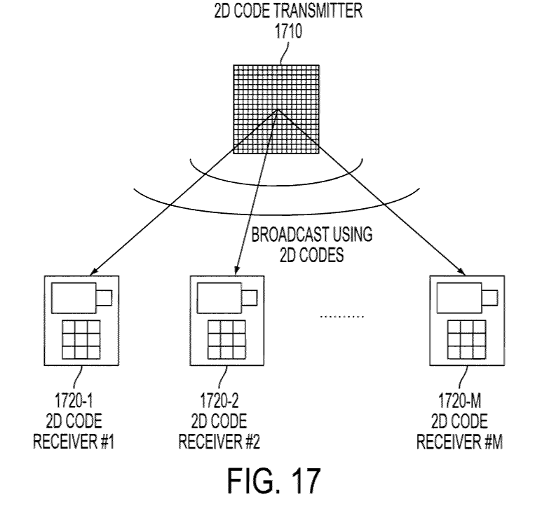

While a point-to-point 2D code communication system has been described above, an exemplary point-to-multipoint 2D code communication system will be described below with reference to FIG. 17.

FIG. 17 illustrates point-to-multipoint 2D code communication in a 2D code communication system according to an exemplary embodiment of the present invention.

Referring to FIG. 17, a 2D code transmitter 1710 broadcasts information to multiple devices using 2D codes. Herein, the same 2D codes are transmitted to multiple 2D code receivers 1720-1, 1720-2 and 1720-M. In an exemplary implementation, a display in a sports stadium may provide supplementary information on the players that users can receive using their camera devices.

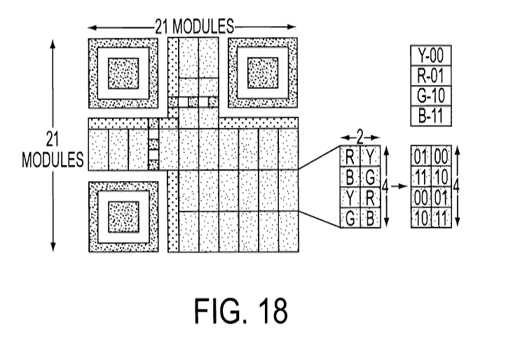

Described below with reference to FIG. 18 is an exemplary technique for encoding 2D codes with a higher bit density.

FIG. 18 illustrates a structure of a color 2D code for use in a 2D code communication system according to an exemplary embodiment of the present invention.

Referring to FIG. 18, a color 2D code symbol is used in order to carry more data bits per 2D code. For example, using Red (R), Yellow (Y), Green (G) and Blue colors, two bits of information can be carried per element. This allows two times more information to be encoded in a color 2D code as compared to a black and white 2D code. Similarly, the use of more colors, allows even more bits to be encoded in a color 2D code.

In an exemplary embodiment of the present invention, the sequence of codes transmitted may include the same overall pattern but with varying colors. For example, given a code with a pattern (e.g. a QR code), the pattern may remain the same for successive 2D codes but the colors in the pattern may vary for successive 2D codes. In other words, the colors of the filled in parts could be changed for each 2D code. Alternatively, a black pattern may be used while the “white areas” change color. This way the pattern stays the same, but the colors change. In other words, each 2D code can be considered as a grid of squares with each square having a specific color that changes in each of the 2D codes that make up a sequence of 2D codes.

In an exemplary implementation, the cascading codes of this invention may be hidden, for example, in a digital movie, with each code being contained in a new frame. That way, it can be used as a watermark (or hidden message) in a digital movie.

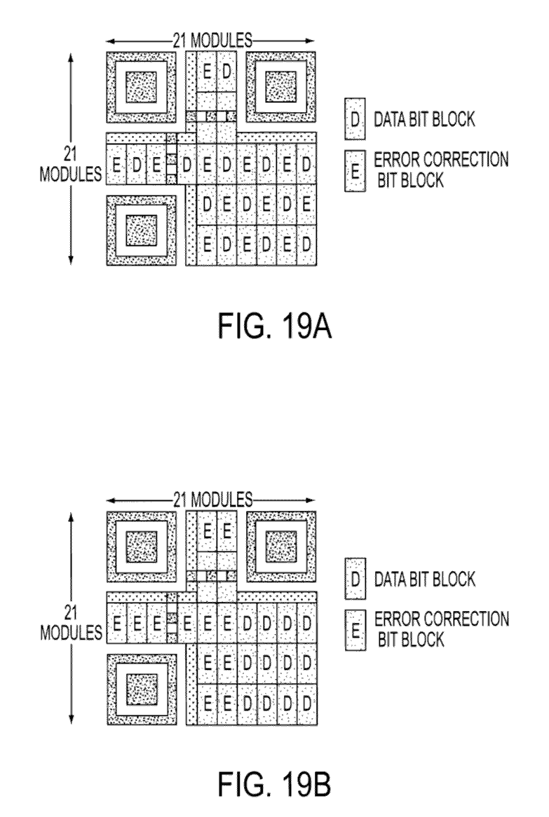

Described below with reference to FIGS. 19A and 19B is an exemplary technique for encoding 2D codes with error correction bits.

FIGS. 19A and 19B illustrate structures of 2D codes including interleaved error correction bits for use in a 2D code communication system according to an exemplary embodiment of the present invention.

The encoded bits consisting of the data bits (or information bits) and error correction bits are randomly or systematically interleaved or interlaced such that they are placed into physical matrix modules of a color 2D code or a black and white 2D code. As shown in FIG. 19A the data bit blocks and error correction bit blocks are interlaced evenly and distributed uniformly in the matrix modules. Alternatively, as shown in FIG. 19B, the data bit blocks and error correction bit blocks are divided separately.

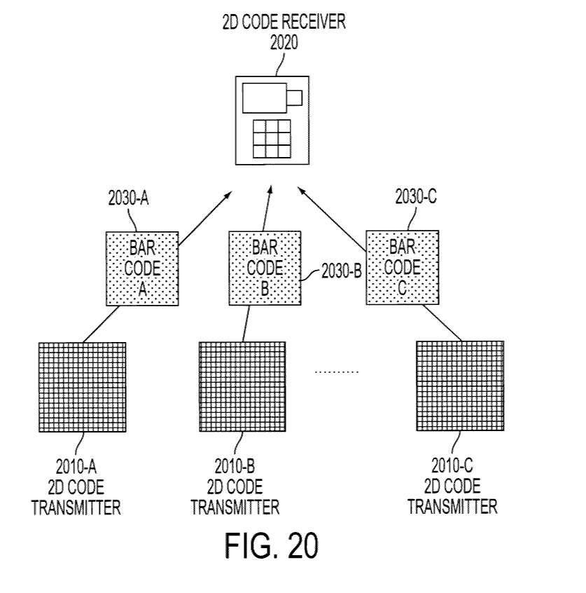

An exemplary multipoint-to-point 2D code communication system is described hereafter with reference to FIG. 20.

FIG. 20 illustrates multipoint-to-point 2D code communication in a 2D code communication system according to an exemplary embodiment of the present invention.

Referring to FIG. 20, 2D code transmitters 2010-A, 2010-B, and 2010-C transmit information to a 2D code receiver 2020 using 2D codes. Herein, 2D code transmitters 2010-A, 2010-B, and 2010-C transmit 2D codes 2030-A, 2030-B, and 2030-C, respectively. In an exemplary implementation, 2D codes 2030-A, 2030-B, and 2030-C are different and can be used to identify the 2D code transmitters 2010-A, 2010-B, and 2010-C.

In an exemplary embodiment of the present invention, the 2D codes are scalable and the transmission has an adaptive feature such as joint source-channel coding. For stored information (e.g. a file), multiple images (multiple 2D codes) could be simultaneously transmitted in one screen (e.g., for a large sized screen). For the information which can be 2D coded on the fly, not only the resolution (version) of the 2D codes can be selected based on the channel information, but also the size of the image of the 2D code can be adjusted based on the screen size and the channel information. Herein, a feature of the 2D transmitter, such as the contrast of a display, could be adjusted as well based on the channel information. For example, if the channel is not good, the contrast can be increased to make the image more easily detectable. Accordingly, the 2D communication may be adaptive.

In another exemplary embodiment of the present invention, 2D codes with different error protection can be used to transmit different information with diverse reliability requirements. For example, it is generally advantageous to employ more robust error protection in control signaling than for payload data, such as audio, where the reliability requirement is not high. Thus, in one exemplary embodiment, control signaling in 2D codes is implemented with more error protection than the payload data.

In another exemplary embodiment of the present invention, a superposition technique may be employed. In other words, some information may be embedded into 2D codes at locations typically reserved for another purpose. For example, if only two versions of the 2D codes are to be implemented in a 2D code communication system, and if the version of the 2D code can be detected by the 2D receiver, the version information itself can be transmitted using only 1 bit. If the 2D codes are always transmitted in a unit of two 2D codes, then we can have four combinations, which are actually transmitted in two bits.

In another exemplary embodiment of the present invention, if a device has multiple 2D code receivers, the communication may employ Multiple Input Multiple Output (MIMO)-like cooperative approaches. In other words, if 2D codes are transmitted in a synchronized way by multiple 2D code transmitters, one 2D code receiver receives multiple 2D codes from multiple 2D code transmitters and may jointly decode these 2D codes.

Accordingly, exemplary embodiments of the present invention employ a 2D code communication system using 2D code communication techniques in order to transfer large amounts of information using 2D bar codes. Any of the 2D code communication systems described above may implement any combination of the above described 2D code communication techniques.

Certain aspects of the present invention may also be embodied as computer readable code on a computer readable recording medium. A computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a Two-Dimensional (2D) code receiver in a 2D code communication system, the method comprising:
receiving a sequence of 2D codes from a 2D code transmitter having data encoded therein, wherein the 2D codes of the sequence are received in succession; and
decoding the received sequence of 2D codes into the data.

2. The method of claim 1, wherein the receiving of the sequence of the 2D codes comprises:
receiving a 2D code from the 2D code transmitter;
determining if the received 2D code is the last 2D code of the sequence of 2D codes; and
if the received 2D code is determined not to be the last 2D code of the sequence of 2D codes, buffering the received 2D code and receiving a next 2D code from the 2D code transmitter.

3. The method of claim 2, wherein the received sequence of 2D codes are decoded into the data if the received 2D code is determined to be the last 2D code of the sequence of 2D codes.

4. The method of claim 1, wherein the receiving of the sequence of the 2D codes comprises synchronizing the 2D code receiver to a code transmission rate of the 2D code transmitter.

5. The method of claim 4, wherein the 2D code receiver is synchronized to the 2D code transmitter using at least one of an occurrence and a location of at least one of a functional field and a timing pattern in one or more 2D codes of the sequence of the 2D codes.

6. The method of claim 1, wherein the receiving of the sequence of the 2D codes comprises determining supportable resolution information based on a 2D code received from the 2D code transmitter, and wherein the method further comprises transmitting the supportable resolution information to the 2D code transmitter.

7. The method of claim 1, further comprising:
determining if any received 2D codes are unsuccessfully decoded;
if any of the 2D codes are determined to be unsuccessfully decoded, transmitting a Negative ACknowledgement (NACK) to the 2D code transmitter that identifies one or more of the unsuccessfully decoded 2D codes; and
if the NACK is transmitted, receiving one or more retransmitted 2D codes that correspond to the one or more 2D codes identified in the NACK.

8. The method of claim 1, further comprising:
determining if any received 2D codes are one of successfully and unsuccessfully decoded;
if any of the received 2D codes are determined to be successfully decoded, transmitting an ACknowledgement (ACK) to the 2D code transmitter that identifies one or more of the successfully decoded 2D codes; and
if any of the received 2D codes are determined to be unsuccessfully decoded, receiving one or more retransmitted 2D codes that correspond to the one or more unsuccessfully decoded 2D codes.

9. The method of claim 1, wherein each of the 2D codes comprises a plurality of 2D sub-codes, wherein the data encoded in each of the 2D codes is one of spread over the 2D sub-codes corresponding to each 2D code and repeated in each of the 2D sub-codes corresponding to each 2D code.

10. The method of claim 9, further comprising:
determining if any received 2D sub-codes are unsuccessfully decoded;
if any of the 2D sub-codes are determined to be unsuccessfully decoded, transmitting a Negative ACknowledgement (NACK) to the 2D code transmitter that identifies one or more of the unsuccessfully decoded 2D sub-codes; and
if the NACK is transmitted, receiving one or more retransmitted 2D sub-codes that correspond to the one or more 2D sub-codes identified in the NACK.

11. The method of claim 9, further comprising:
determining if any received 2D sub-codes are one of successfully and unsuccessfully decoded;
if any of the received 2D sub-codes are determined to be successfully decoded, transmitting an ACknowledgement (ACK) to the 2D code transmitter that identifies one or more of the successfully decoded 2D sub-codes; and
if any of the received 2D sub-codes are determined to be unsuccessfully decoded, receiving one or more retransmitted 2D sub-codes that correspond to the one or more unsuccessfully decoded 2D sub-codes.

12. The method of claim 1, further comprising:
receiving another sequence of 2D codes from another 2D code transmitter having other data encoded therein; and
decoding the received other sequence of 2D codes into the other data,
wherein the sequence of 2D codes and the other sequence of 2D codes are received and decoded at the same time.

13. The method of claim 1, wherein each of the 2D codes comprises a plurality of colors.

14. The method of claim 1, wherein each of the 2D codes comprises error correction bit blocks and data bit blocks that are one of randomly and orderly mapped within each 2D code.

15. The method of claim 1, wherein the decoding of the received 2D codes into the data comprises:
demapping 2D codes of the received sequence of 2D codes into respective coded symbols;
channel decoding the coded symbols into respective data blocks; and
reassembling the data blocks into the data.

16. A method for operating a Two-Dimensional (2D) code transmitter in a 2D code communication system, the method comprising:
encoding data into a sequence of 2D codes; and
transmitting the sequence of 2D codes to a 2D code receiver, wherein the 2D codes of the sequence are transmitted in succession.

17. The method of claim 16, wherein the encoding of the data into a sequence of 2D codes comprises:
segmenting the data into data blocks;
channel coding each segmented data block into a coded symbol; and
mapping each coded symbol into a 2D code.

18. The method of claim 16, wherein the transmitting of the sequence of 2D codes to a 2D code receiver comprises:
receiving supportable resolution information from the 2D code receiver; and
transmitting the sequence of 2D codes to a 2D code receiver based on the supportable resolution information received from the 2D code receiver.

19. The method of claim 16, wherein one or more of the 2D codes of the sequence comprises at least one of a functional field and a timing pattern.

20. The method of claim 16, further comprising:
receiving a Negative ACknowledgement (NACK) from the 2D code receiver that identifies one or more unsuccessfully decoded 2D codes; and
retransmitting 2D codes to the 2D code receiver that are identified in the NACK.

21. The method of claim 16, further comprising:
determining if an ACknowledgement (ACK) is not received from the 2D code receiver that identifies one or more 2D codes transmitted to the 2D code receiver that are successfully decoded by the 2D code receiver; and
if the ACK is determined not to have been received, retransmitting the one or more 2D codes to the 2D code receiver.

22. The method of claim 16, wherein each of the 2D codes comprises a plurality of 2D sub-codes, wherein the data encoded in each of the 2D codes is one of spread over the 2D sub-codes corresponding to each 2D code and repeated in each of the 2D sub-codes corresponding to each 2D code.

23. The method of claim 22, further comprising:
receiving a Negative ACknowledgement (NACK) from the 2D code receiver that identifies one or more unsuccessfully decoded 2D sub-codes; and
retransmitting 2D sub-codes to the 2D code receiver that are identified in the NACK.

24. The method of claim 22, further comprising:
determining if an ACknowledgement (ACK) is not received from the 2D code receiver that identifies one or more 2D sub-codes transmitted to the 2D code receiver that are successfully decoded by the 2D code receiver; and
if the ACK is determined not to have been received, retransmitting the one or more 2D sub-codes to the 2D code receiver.

25. The method of claim 16, wherein the transmitting of the sequence of 2D codes to a 2D code receiver comprises transmitting the sequence of 2D codes to a plurality of 2D code receivers.

26. The method of claim 16, wherein each of the 2D codes comprises a plurality of colors.

27. The method of claim 16, wherein each of the 2D codes comprises error correction bit blocks and data bit blocks that are one of randomly and orderly mapped within each 2D code.

28. A Two-Dimensional (2D) code receiving apparatus for use in a 2D code communication system, the apparatus comprising:
a 2D code receiver for receiving a sequence of 2D codes from a 2D code transmitter having data encoded therein, wherein the 2D codes of the sequence are received in succession; and
a processor for decoding the received sequence of 2D codes into the data.

29. The apparatus of claim 28, wherein, for each 2D code received, the processor determines if the received 2D code is the last 2D code of the sequence of 2D codes, and if the received 2D code is determined not to be the last 2D code of the sequence of 2D codes, the processor buffers the received 2D code and determines if the next received 2D code is the last 2D code of the sequence of 2D codes.

30. The apparatus of claim 29, wherein when the processor determines that the received 2D code is the last 2D code of the sequence of 2D codes, the processor decodes the received sequence of 2D codes into the data.

31. The apparatus of claim 28, wherein the processor synchronizes to a code transmission rate of the 2D code transmitter.

32. The apparatus of claim 31, wherein the processor synchronizes to the code transmission rate of the 2D code transmitter based on at least one of an occurrence and a location of at least one of a functional field and a timing pattern in one or more 2D codes of the sequence of the 2D codes.

33. The apparatus of claim 28, further comprising a transmitter, wherein the processor determines supportable resolution information based on a 2D code received from the 2D code transmitter and generates a message comprising the supportable resolution information, and the transmitter transmits the supportable resolution information to the 2D transmitter.

34. The apparatus of claim 28, further comprising a transmitter, wherein the processor determines if any received 2D codes are unsuccessfully decoded, and if the processor determines that any of the received 2D codes are unsuccessfully decoded, the processor generates a Negative ACknowledgement (NACK) for transmission by the transmitter to the 2D code transmitter that identifies one or more of the unsuccessfully decoded 2D codes, and if the NACK is transmitted, the receiver receives one or more retransmitted 2D codes that correspond to the one or more 2D codes identified in the NACK.

35. The apparatus of claim 28, further comprising a transmitter, wherein the processor determines if any received 2D codes are one of successfully and unsuccessfully decoded, if the processor determines that any of the received 2D codes are successfully decoded, the processor generates an ACknowledgement (ACK) for transmission by the transmitter to the 2D code transmitter that identifies one or more of the successfully decoded 2D codes, and if any of the received 2D codes are determined to be unsuccessfully decoded, the receiver receives one or more retransmitted 2D codes from the 2D transmitter that correspond to the one or more unsuccessfully decoded 2D codes.

36. The apparatus of claim 28, wherein each of the 2D codes comprises a plurality of 2D sub-codes, wherein the data encoded in each of the 2D codes is one of spread over the 2D sub-codes corresponding to each 2D code and repeated in each of the 2D sub-codes corresponding to each 2D code.

37. The apparatus of claim 36, further comprising a transmitter,
wherein the processor determines if any received 2D sub-codes are unsuccessfully decoded, and if the processor determines that any of the received 2D sub-codes are unsuccessfully decoded, the processor generates a Negative ACknowledgement (NACK) for transmission by the transmitter to the 2D code transmitter that identifies one or more of the unsuccessfully decoded 2D sub-codes, and if the NACK is transmitted, the receiver receives one or more retransmitted 2D sub-codes that correspond to the one or more 2D sub-codes identified in the NACK.

38. The apparatus of claim 36, further comprising a transmitter,
wherein the processor determines if any received 2D sub-codes are one of successfully and unsuccessfully decoded, if the processor determines that any of the received 2D sub-codes are successfully decoded, the processor generates an ACknowledgement (ACK) for transmission by the transmitter to the 2D code transmitter that identifies one or more of the successfully decoded 2D sub-codes, and if any of the received 2D sub-codes are determined to be unsuccessfully decoded, the receiver receives one or more retransmitted 2D sub-codes from the 2D transmitter that correspond to the one or more unsuccessfully decoded 2D sub-codes.

39. The apparatus of claim 28, wherein the a 2D code receiver receives another sequence of 2D codes from another 2D code transmitter having other data encoded therein, and the processor decodes the received other sequence of 2D codes into the other data, further wherein the sequence of 2D codes and the other sequence of 2D codes are received and decoded at the same time.

40. The apparatus of claim 28, wherein each of the 2D codes comprises a plurality of colors.

41. The apparatus of claim 28, wherein each of the 2D codes comprises error correction bit blocks and data bit blocks that are one of randomly and orderly mapped within each 2D code.

42. The apparatus of claim 28, wherein when decoding the received 2D codes into the data, the processor demaps 2D codes of the received sequence of 2D codes into respective coded symbols, channel decodes the coded symbols into respective data blocks; and reassembles the data blocks into the data.

43. A Two-Dimensional (2D) code transmitting apparatus for use in a 2D code communication system, the apparatus comprising:
a processor for encoding data into a sequence of 2D codes; and
a 2D code transmitter for transmitting the sequence of 2D codes to a 2D code receiver, wherein the 2D codes of the sequence are transmitted in succession.

44. The apparatus of claim 43, wherein when encoding the data into a sequence of 2D codes, the processor segments the data into data blocks, channel codes each segmented data block into a coded symbol, and maps each coded symbol into a 2D code.

45. The apparatus of claim 43, further comprising a receiver for receiving supportable resolution information from the 2D code receiver,
wherein the 2D code transmitter transmits the sequence of 2D codes to a 2D code receiver based on the supportable resolution information received from the 2D code receiver.

46. The apparatus of claim 43, wherein one or more of the 2D codes of the sequence comprises at least one of a functional field and a timing pattern.

47. The apparatus of claim 43, further comprising a receiver for receiving a Negative ACknowledgement (NACK) from the 2D code receiver that identifies one or more unsuccessfully decoded 2D codes,
wherein the 2D code transmitter retransmits the one or more 2D codes to the 2D code receiver that are identified in the NACK.

48. The apparatus of claim 43, further comprising a receiver for receiving an ACknowledgement (ACK) from the 2D code receiver that identifies one or more 2D codes transmitted to the 2D code receiver that are successfully decoded by the 2D code receiver,
wherein the processor determines if the ACK is not received from the 2D code receiver, if the processor determines that the ACK is not received, the transmitter retransmits the one or more 2D codes to the 2D code receiver.

49. The apparatus of claim 43, wherein each of the 2D codes comprises a plurality of 2D sub-codes, wherein the data encoded in each of the 2D codes is spread over 2D sub-codes corresponding to each 2D sub-code and repeated in each 2D sub-code corresponding to each 2D sub-code.

50. The apparatus of claim 49, further comprising a receiver for receiving a Negative ACknowledgement (NACK) from the 2D code receiver that identifies one or more unsuccessfully decoded 2D sub-codes,
wherein the 2D code transmitter retransmits the one or more 2D sub-codes to the 2D code receiver that are identified in the NACK.

51. The apparatus of claim 49, further comprising a receiver for receiving an ACknowledgement (ACK) from the 2D code receiver that identifies one or more 2D sub-codes transmitted to the 2D code receiver that are successfully decoded by the 2D sub-code receiver,
wherein the processor determines if the ACK is not received from the 2D code receiver, if the processor determines that the ACK is not received, the transmitter retransmits the one or more 2D sub-codes to the 2D code receiver.

52. The apparatus of claim 43, wherein the 2D code transmitter transmits the sequence of 2D codes to a plurality of 2D code receivers.

53. The apparatus of claim 43, wherein each of the 2D codes comprises a plurality of colors.

54. The apparatus of claim 43, wherein each of the 2D codes comprises error correction bit blocks and data bit blocks that are one of randomly and orderly mapped within each 2D code.
